(19) United States
(12) Patent Application Publication
(10) Pub. No.: US 2015/0113805 A1
(43) Pub. Date: Apr. 30, 2015

(54) METHOD OF ASSEMBLING A GAS TURBINE ENCLOSURE

(71) Applicant: General Electric Company, Schenectady, NY (US)

(72) Inventors: Kyle Joseph Conger, Greenville, SC (US); Daniel Neal Alvarez, Greenville, SC (US); Matthew John Canham, Simpsonville, SC (US); Ronald Lawrence Yenser, Simpsonville, SC (US)

(21) Appl. No.: 14/068,627

(22) Filed: Oct. 31, 2013

(51) Int. Cl. F01D 25/24; F02C 7/24

(52) U.S. Cl. CPC F01D 25/24; F02C 7/24; F05D 2230/60
USPC 29/888

(57) ABSTRACT

A method of assembling an enclosure of a gas turbine is provided. The method includes disposing gas turbine equipment in an interior of a frame at a first site, connecting wall panels to the frame to form a pre-assembled module at the first site, shipping the pre-assembled module from the first site to a second site and disposing the pre-assembled module proximate to the gas turbine such that the gas turbine equipment is exposed for connection to the gas turbine and a portion of the wall panels form a portion of an outer enclosure of the gas turbine and the gas turbine equipment.

### BACKGROUND OF THE INVENTION

The subject matter disclosed herein relates to a method of assembling a gas turbine enclosure. More particularly, the subject matter disclosed herein relates to a method of assembling a gas turbine enclosure using pre-assembled modules.

Gas turbines generally include a compressor, a combustor and a turbine section. The compressor is configured to compress inlet air which is then mixed with fuel and combusted in the combustor to form a high temperature and high pressure working fluid. The working fluid is received in the turbine section where it is expanded to generate mechanical energy. This mechanical energy is used to drive rotation of the compressor and may be employed in the production of electricity. Gas turbines are often coupled to a substantial number of components, such as piping, valves, electrical devices, etc., and enclosed within an enclosure that provides for sound attenuation.

In gas turbine assembly processes, the various components of a gas turbine are shipped to a site where the gas turbine is to be built and assembled at the site. Since the site is often located at a remote area where the gas turbine operations will not disturb the local population, costs associated with the shipping and the labor needed to complete the assembly processes may be substantial. In addition, any issues confronted during the on-site assembly processes often cannot be easily corrected. In the case of faulty components, the components need to be shipped back to their factory and replacement parts need to be re-shipped to the assembly site. This adds to the time and labor costs associated with normal assembly processes and can also lead to delays in construction schedules.

### BRIEF DESCRIPTION OF THE INVENTION

According to one aspect of the invention, a method of assembling an enclosure of a gas turbine is provided. The method includes disposing gas turbine equipment in an interior of a frame at a first site, connecting wall panels to the frame to form a pre-assembled module at the first site, shipping the pre-assembled module from the first site to a second site and disposing the pre-assembled module proximate to the gas turbine such that the gas turbine equipment is exposed for connection to the gas turbine and a portion of the wall panels form a portion of an outer enclosure of the gas turbine and the gas turbine equipment.

According to another aspect of the invention, a method of assembling an enclosure of a gas turbine is provided. The method includes disposing gas turbine equipment in an interior of a frame at a first site, connecting permanent acoustic wall and temporary shipping container panels to the frame to form a pre-assembled module at the first site, shipping the pre-assembled module from the first site to a second site, disposing the pre-assembled module proximate to the gas turbine such that the permanent acoustic wall panels form a portion of an outer enclosure of the gas turbine and the gas turbine equipment and removing the temporary shipping container panels from the frame such that the gas turbine equipment is exposed for connection to the gas turbine.

According to yet another aspect of the invention, a method of assembling a gas turbine enclosure apparatus for enclosing a gas turbine is provided. The method includes pre-assembling a plurality of modules comprising at least one or more module types, the pre-assembling comprising disposing gas turbine equipment in an interior of a frame and connecting wall panels with the frame at a first site, shipping the plurality of modules from the first site to a second site and disposing the plurality of modules proximate to the gas turbine such that the gas turbine equipment is exposed for connection to the gas turbine and the wall panels of each module of the plurality of modules form a portion of an outer enclosure of the gas turbine and the gas turbine equipment.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a gas turbine in accordance with embodiments;

FIG. 2 is a perspective view of a fuel control module being disposed proximate to the gas turbine of FIG. 1 in accordance with embodiments;

FIG. 3 is a perspective view of an air extraction module being disposed proximate to the gas turbine of FIG. 1 in accordance with embodiments;

FIG. 4 is a perspective view of a drainage module being disposed proximate to the gas turbine of FIG. 1 in accordance with embodiments;

FIG. 5 is a perspective view of an additional air extraction module being disposed proximate to the gas turbine of FIG. 1 in accordance with embodiments;

FIG. 6 is a perspective view of work platforms and a grating of an enclosure of the gas turbine of FIG. 1 in accordance with embodiments;

FIG. 7 is a perspective view of a roof of an enclosure of the gas turbine of FIG. 1 in accordance with embodiments;

FIG. 8 is a flow diagram illustrating a method of assembling an enclosure of a gas turbine; and

FIG. 9 is a flow diagram illustrating a method of assembling a gas turbine enclosure apparatus for enclosing a gas turbine in accordance with embodiments.

The detailed description explains embodiments of the invention, together with advantages and features, by way of example with reference to the drawings.

### DETAILED DESCRIPTION OF THE INVENTION

The accessory piping, valves, electrical and other components of a gas turbine to be assembled are packaged within modules that arrive at the site of the gas turbine pre-assembled and commissioned. This pre-assembly enables faster plant erection, reduced erection cost and reduced quality defects.

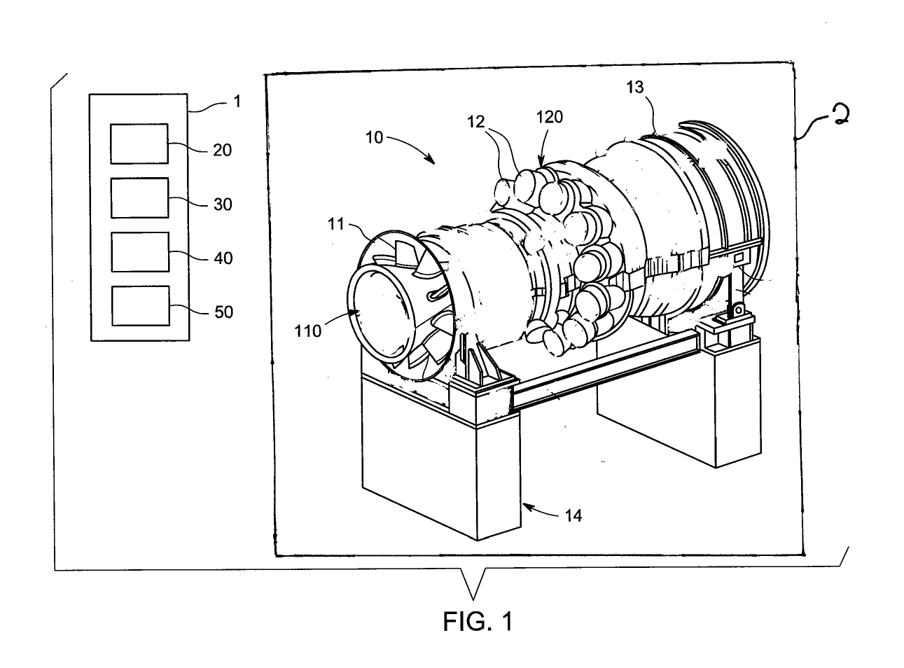

With reference to FIG. 1, a gas turbine 10 is provided. The gas turbine 10 includes a compressor 11, a combustor 12 and a turbine section 13. The compressor 11 includes an inlet 110, which is receptive of inlet air, and is configured to compress the inlet air. The combustor 12 may be provided as an annular combustor or as a plurality of combustors 12 arranged in a can-annular array 120. The combustor 12 or the combustors 12 of the can-annular array 120 is/are configured to mix the compressed inlet air with fuel and to combust the fuel to form a high temperature and high pressure working fluid. The working fluid is received in the turbine section 13 where it is expanded to generate mechanical energy. This mechanical energy is used to drive rotation of the compressor and may be employed in the production of electricity.

While a plurality of pre-assembled modules are pre-assembled at a first site 1, as will be described below, the gas turbine 10 is disposable at a second site 2. The second site 2 may be remote from the first site 1. At the second site, the gas turbine 10 is supported on a base 14

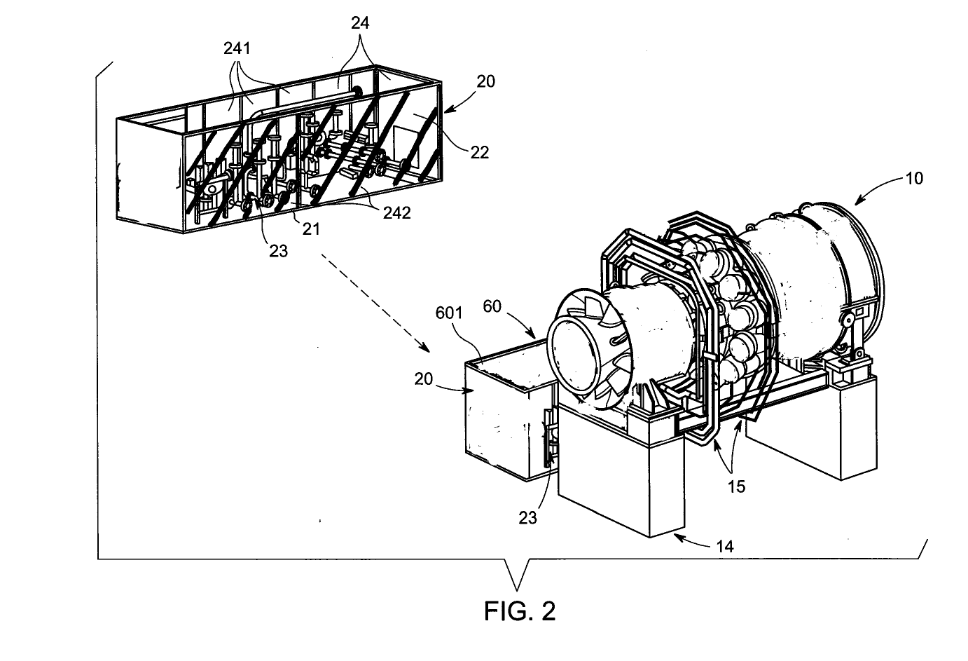

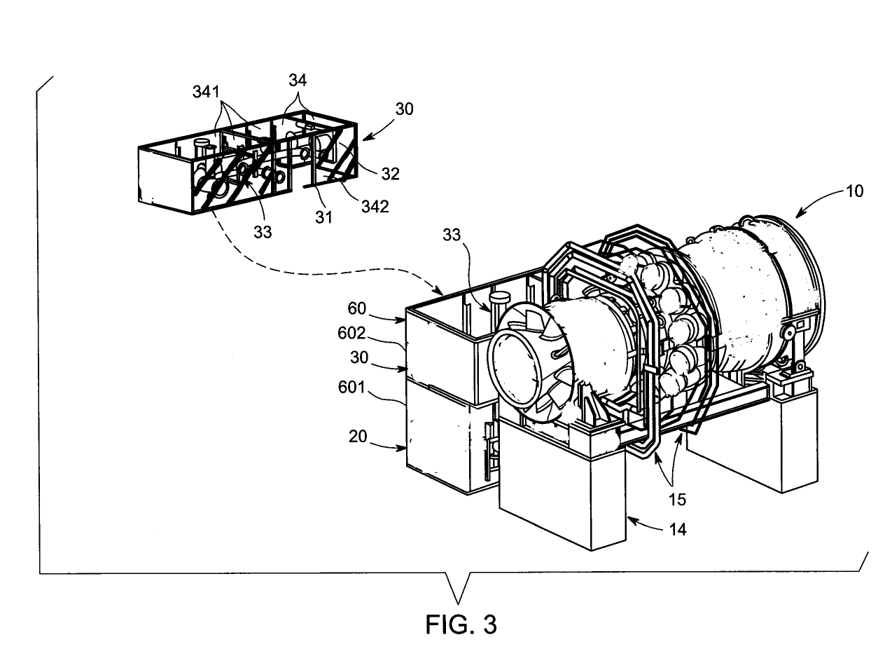

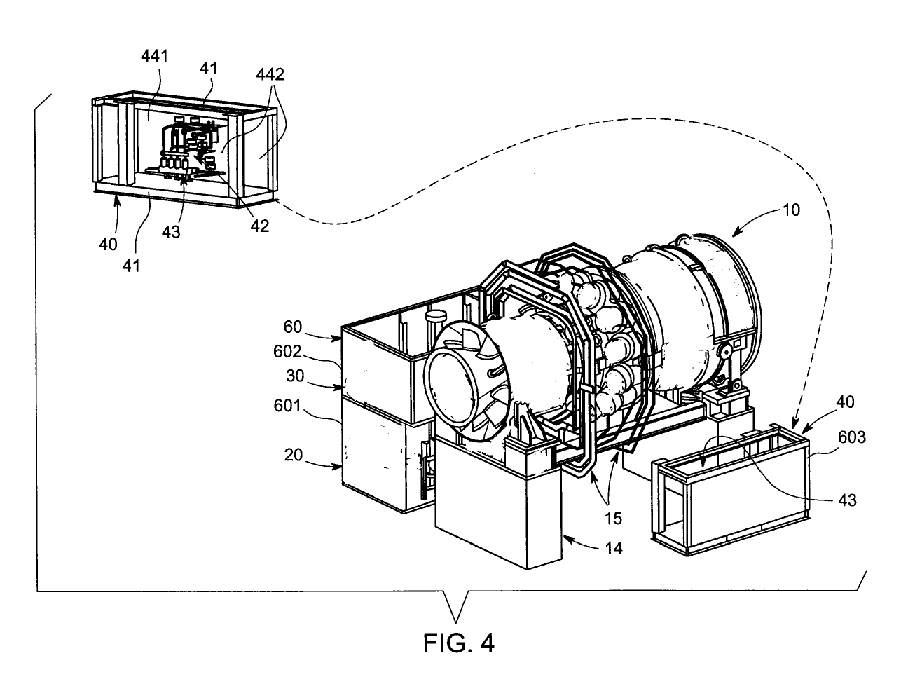

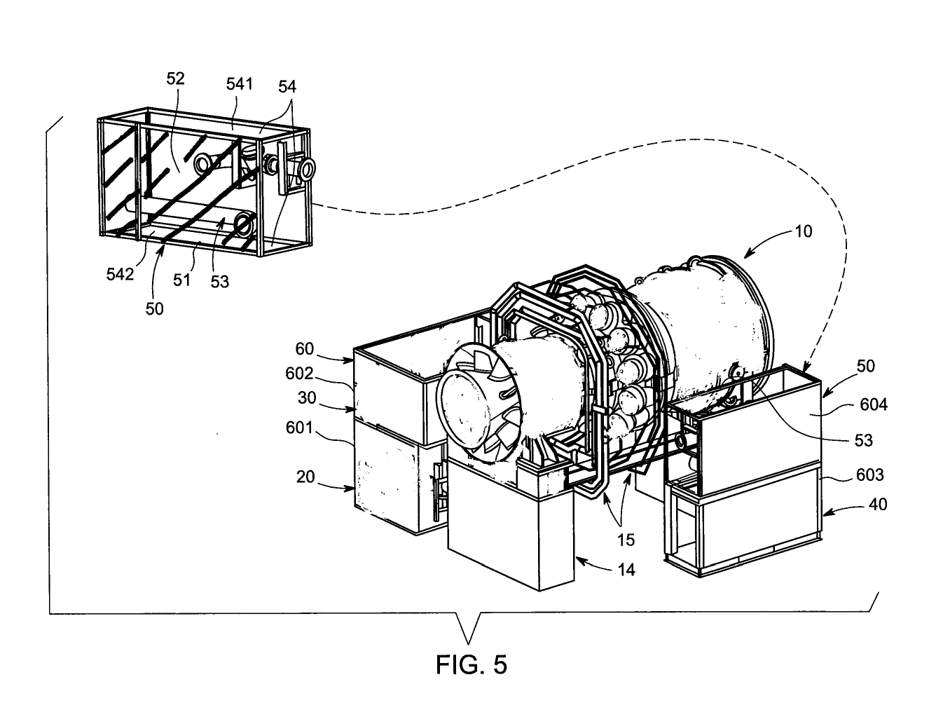

Each one of the plurality of pre-assembled modules may be assembled at the first site 1 and the plurality of pre-assembled modules includes one or more module types. Typical modules may include a fuel control module 20 (see FIG. 2), an air extraction module 30 (see FIG. 3), a drainage module 40 (see FIG. 4) and an additional air extraction module 50 (see FIG. 5).

With reference to FIG. 2, the fuel control module 20 includes a frame 21, which is provided as a substantially rectangular volume defining an interior 22, gas turbine equipment 23, which is disposed in the interior 22, and wall panels 24. The gas turbine equipment 23 is pre-assembled in the interior 22 at the first site 1 and includes some combination of piping, piping supports, valves and electrical devices and is connectable with fuel and air manifolds 15 of the gas turbine 10 disposed at the second site 2. The wall panels 24 are connectable with the frame 21 and include permanent acoustic wall panels 241 and temporary shipping container panels 242.

As shown in FIG. 2, the fuel control module 20 may be pre-assembled at the first site 1 and shipped from the first site 1 to the second site 2. At the second site 2, the temporary shipping container panels 242 are removed and the fuel control module 20 is disposed proximate to the gas turbine 10 on a level with the base 14. With the temporary shipping container panels 242 removed, the gas turbine equipment 23 is exposed vertically and is exposed laterally for connection to the gas turbine engine 10 and, more particularly, to the fuel and air manifolds 15 of the gas turbine 10. The permanent acoustic wall panels 241 form a first portion 601 of an outer enclosure 60 of the gas turbine 10 and the gas turbine equipment 23.

With reference to FIG. 3, the air extraction module 30 includes a frame 31, which is provided as a substantially rectangular volume defining an interior 32, gas turbine equipment 33, which is disposed in the interior 32 and wall panels 34. The gas turbine equipment 33 is pre-assembled in the interior 32 at the first site 1 and includes some combination of piping, piping supports, valves and electrical devices and is connectable with the gas turbine 10 disposed at the second site 2. The wall panels 34 are connectable with the frame 31 and include permanent acoustic wall panels 341 and temporary shipping container panels 342.

As shown in FIG. 3, the air extraction module 30 may be pre-assembled at the first site 1 and shipped from the first site 1 to the second site 2. At the second site 2, the temporary shipping container panels 342 are removed and the air extraction module 30 is disposed proximate to the gas turbine 10. More particularly, the air extraction module 30 is disposed atop the fuel control module 20 where some of the temporary shipping container panels 242 were removed such that the air extraction module 30 is disposed on a level with the gas turbine 10. With the temporary shipping container panels 342 removed, the gas turbine equipment 33 is exposed for connection to the gas turbine engine 10. The permanent acoustic wall panels 341 form a second portion 602 of the outer enclosure 60.

With reference to FIG. 4, the drainage module 40 includes a frame 41, which is provided as a substantially rectangular volume defining an interior 42, gas turbine equipment 43, which is disposed in the interior 42, and wall panels 44. The gas turbine equipment 43 is pre-assembled in the interior 42 at the first site 1 and includes some combination of piping, piping supports, valves and electrical devices and is connectable with the gas turbine 10 disposed at the second site 2. The wall panels 44 are connectable with the frame 41 and include permanent acoustic wall panels 441 and temporary shipping container panels 442.

As shown in FIG. 4, the drainage module 40 may be pre-assembled at the first site 1 and shipped from the first site 1 to the second site 2. At the second site 2, the temporary shipping container panels 442 are removed and the drainage module 40 is disposed proximate to the gas turbine 10 on a level with the base 14 at a side opposite the fuel control module 20. With the temporary shipping container panels 442 removed, the gas turbine equipment 43 is exposed vertically and is exposed laterally for connection to the gas turbine engine 10. The permanent acoustic wall panels 441 form a third portion 603 of the outer enclosure 60.

With reference to FIG. 5, the additional air extraction module 50 includes a frame 51, which is provided as a substantially rectangular volume defining an interior 52, gas turbine equipment 53, which is disposed in the interior 52, and wall panels 54. The gas turbine equipment 53 is pre-assembled in the interior 52 at the first site 1 and includes some combination of piping, piping supports, valves and electrical devices and is connectable with the gas turbine 10 disposed at the second site 2. The wall panels 54 are connectable with the frame 51 and include permanent acoustic wall panels 541 and temporary shipping container panels 542.

As shown in FIG. 5, the additional air extraction module 50 may be pre-assembled at the first site 1 and shipped from the first site 1 to the second site 2. At the second site 2, the temporary shipping container panels 542 are removed and the additional sealing module 50 is disposed proximate to the gas turbine 10. More particularly, the additional air extraction module 50 is disposed atop the drainage module 40 where some of the temporary shipping container panels 442 were removed such that the additional sealing module 50 is disposed on a level with the gas turbine 10. With the temporary shipping container panels 542 removed, the gas turbine equipment 53 is exposed for connection to the gas turbine engine 10. The permanent acoustic wall panels 541 form a fourth portion 604 of the outer enclosure 60.

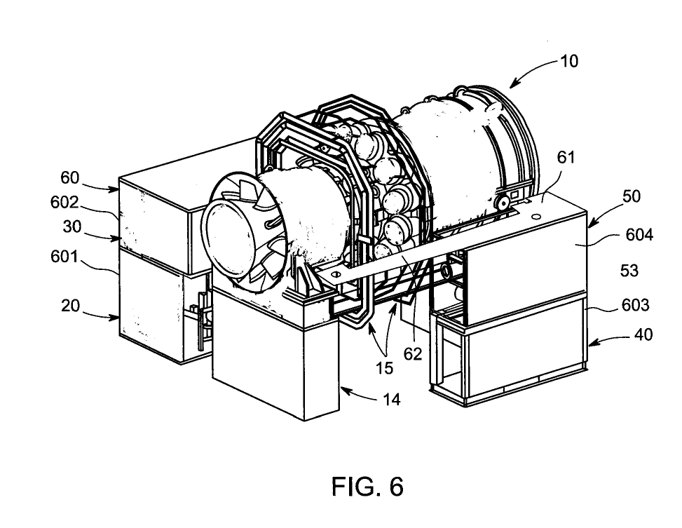

With reference to FIG. 6, work platforms 61 and a grating 62 of the enclosure 60 may be installed at site 2 or pre-installed as part of the above-described modules.

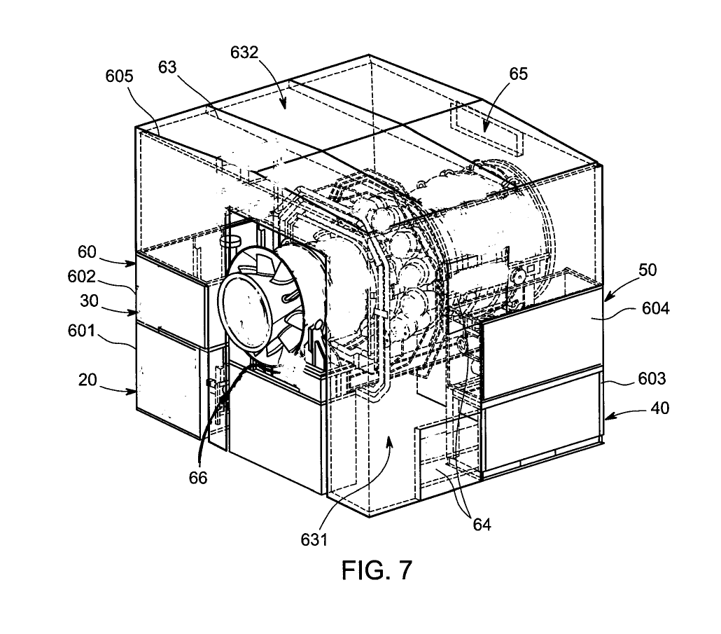

With reference to FIG. 7, a roof 63 that forms a fifth portion 605 of the enclosure 60 may be disposed atop the air extraction module 30 and the additional air extraction module 50 where some of the temporary shipping panels 342 and 542 were removed. The roof 63 includes sidewalls 631 that complete the enclosure in the absence of additional modules, which may or may not include piping, valves and electrical components, and a roof portion 632. The sidewalls 631 may be formed to define various maintenance access points 64, ventilation holes 65 and inlet openings 66.

As noted above, since the gas turbine equipment 23, 33, 43 and 53 is pre-assembled into the various modules on-site assembly processes are limited to connections between the gas turbine equipment 23, 33, 43 and 53 and the gas turbine 10. This can result in substantial reductions in field welding, field installed components and valves, and connections between turbine supplier and plant installer piping systems.

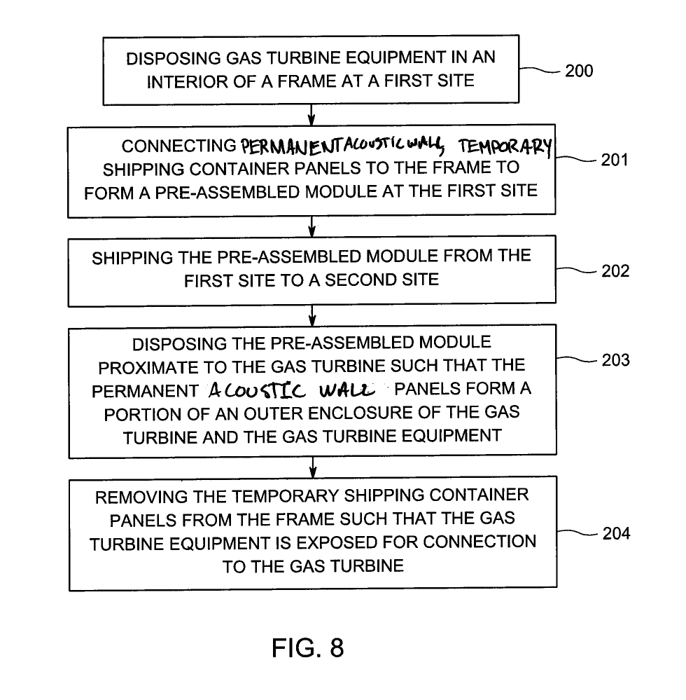

In accordance with aspects and, with reference to FIG. 8, a method of assembling an enclosure of a gas turbine is provided. The method includes disposing gas turbine equipment in an interior of a frame at a first site (operation 200), connecting permanent and temporary shipping container panels to the frame to form a pre-assembled module at the first site (operation 201), shipping the pre-assembled module from the first site to a second site (operation 202), disposing the pre-assembled module proximate to the gas turbine such that the permanent shipping container panels form a portion of an outer enclosure of the gas turbine and the gas turbine equipment (operation 203) and removing the temporary shipping container panels from the frame such that the gas turbine equipment is exposed for connection to the gas turbine (operation 204).

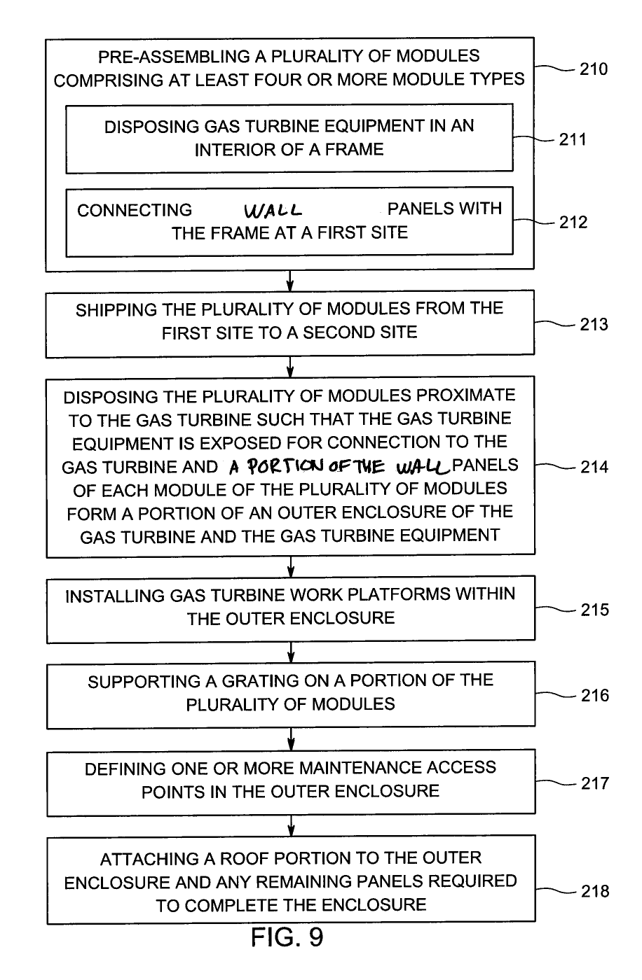

In accordance with further embodiments of the invention and, with reference to FIG. 9, a method of assembling a gas turbine enclosure apparatus for enclosing a gas turbine is provided. The method includes pre-assembling a plurality of modules comprising one or more module types (operation 210), the pre-assembling comprising disposing gas turbine equipment in an interior of a frame (operation 211) and connecting wall panels with the frame at a first site (operation 212), shipping the plurality of modules from the first site to a second site (operation 213) and disposing the plurality of modules proximate to the gas turbine such that the gas turbine equipment is exposed for connection to the gas turbine and a portion of the wall panels of each module of the plurality of modules form a portion of an outer enclosure of the gas turbine and the gas turbine equipment (operation 214).

In accordance with embodiments, the pre-assembling of operation 210 includes pre-assembling a fuel control module, pre-assembling an air extraction module, pre-assembling a drainage module and pre-assembling an additional air extraction module. In accordance with further embodiments, the method may include installing gas turbine work platforms within the outer enclosure (operation 215), supporting a grating on a portion of the plurality of modules (operation 216), defining one or more maintenance access points in the outer enclosure (operation 217) and attaching a roof portion to the outer enclosure along with any remaining panels required to complete the outer enclosure (operation 218).

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of assembling an enclosure of a gas turbine, the method comprising:
disposing gas turbine equipment in an interior of a frame at a first site;
connecting wall panels to the frame to form a pre-assembled module at the first site;
shipping the pre-assembled module from the first site to a second site; and
disposing the pre-assembled module proximate to the gas turbine such that the gas turbine equipment is exposed for connection to the gas turbine and a portion of the wall panels form a portion of an outer enclosure of the gas turbine and the gas turbine equipment.

2. The method according to claim 1, further comprising assembling the frame to have a rectangular volumetric shape.

3. The method according to claim 1, wherein the gas turbine equipment comprises piping, piping supports, valves and electrical devices.

4. The method according to claim 1, wherein the frame and the gas turbine equipment form a fuel control module.

5. The method according to claim 1, wherein the frame and the gas turbine equipment form an air extraction module.

6. The method according to claim 1, wherein the frame and the gas turbine equipment form a drainage module.

7. The method according to claim 1, wherein the wall panels are configured such that the outer enclosure attenuates sound generated by the gas turbine.

8. A method of assembling an enclosure of a gas turbine, the method comprising:
disposing gas turbine equipment in an interior of a frame at a first site;
connecting permanent acoustic wall and temporary shipping container panels to the frame to form a pre-assembled module at the first site;
shipping the pre-assembled module from the first site to a second site;
disposing the pre-assembled module proximate to the gas turbine such that the permanent acoustic wall panels form a portion of an outer enclosure of the gas turbine and the gas turbine equipment; and
removing the temporary shipping container panels from the frame such that the gas turbine equipment is exposed for connection to the gas turbine.

9. The method according to claim 8, further comprising assembling the frame to have a rectangular volumetric shape.

10. The method according to claim 8, wherein the gas turbine equipment comprises piping, piping supports, valves and electrical devices.

11. The method according to claim 8, wherein the frame and the gas turbine equipment form a fuel control module.

12. The method according to claim 8, wherein the frame and the gas turbine equipment form an air extraction module.

13. The method according to claim 8, wherein the frame and the gas turbine equipment form a drainage module.

14. The method according to claim 8, wherein the permanent acoustic panels are configured such that the outer enclosure attenuates sound generated by the gas turbine.

15. A method of assembling a gas turbine enclosure apparatus for enclosing a gas turbine, the method comprising:
pre-assembling a plurality of modules comprising one or more module types,
the pre-assembling comprising disposing gas turbine equipment in an interior of a frame and connecting wall panels with the frame at a first site;
shipping the plurality of modules from the first site to a second site; and
disposing the plurality of modules proximate to the gas turbine such that the gas turbine equipment is exposed for connection to the gas turbine and the wall panels of each module of the plurality of modules form a portion of an outer enclosure of the gas turbine and the gas turbine equipment.

16. The method according to claim 15, wherein the pre-assembling comprises:
pre-assembling a fuel control module;
pre-assembling an air extraction module;
pre-assembling a drainage module; and
pre-assembling an additional air extraction module.

17. The method according to claim 15, further comprising installing gas turbine work platforms within the outer enclosure.

18. The method according to claim 15, further comprising supporting a grating on a portion of the plurality of modules.

19. The method according to claim 15, further comprising defining one or more maintenance access points in the outer enclosure.

20. The method according to claim 15, further comprising attaching a roof portion to the outer enclosure.
